(19) United States
(12) Patent Application Publication
(10) Pub. No.: US 2009/0106297 A1
(43) Pub. Date: Apr. 23, 2009

(54) METHODS AND APPARATUS TO CREATE A MEDIA MEASUREMENT REFERENCE DATABASE FROM A PLURALITY OF DISTRIBUTED SOURCES

(76) Inventors: David Howell Wright, Safety Harbor, FL (US); Christian Curtis, Palm Harbor, FL (US)

Correspondence Address: Hanley, Flight & Zimmerman, LLC, 150 S. Wacker Dr. Suite 2100, Chicago, IL, 60606, US

(21) Appl. No.: 12/048,131

(22) Filed: Mar. 13, 2008

Related U.S. Application Data
(60) Provisional application No. 60/981,026, filed on Oct. 18, 2007.

(51) Int. Cl. G06F 17/30

(52) U.S. Cl. 707/102; 707/E17.001

(57) ABSTRACT

Methods and apparatus to create a media measurement reference database from a plurality of distributed sources are described. An example method of developing a reference database associated with media content includes receiving first identifying data associated with media content from a meter on a first information presentation device, the media content being locally accessible at the first information presentation device; determining whether the reference database includes reference data associated with the first identifying data; when the reference database lacks the reference data associated with the first identifying data, sending a message to the meter requesting first reference data for the media content; and receiving the first reference data associated with the first identifying data.

### RELATED APPLICATION

This application claims priority from U.S. provisional patent application Ser. No. 60/981,026, filed on Oct. 18, 2007, entitled “Methods and Apparatus to Collect Reference Data from Panelists,” which is hereby incorporated by reference in its entirety.

### FIELD OF DISCLOSURE

The present disclosure relates generally to media measurement and, more particularly, to methods and apparatus to create a media measurement reference database from a plurality of distributed sources.

### BACKGROUND

Media-centric companies and/or metering entities such as, for example, advertising companies, broadcast networks, etc. are often interested in the viewing, listening, and/or media behavior interests of audience members or the public in general. Metering data can be used to better market products and/or to improve programming. Techniques used to monitor and/or measure exposure to media content (e.g., radio programs, music, television programming, movies, still images, printed media, recorded media, video games, and/or music videos) often include collecting reference data (e.g., codes (e.g., watermarks), signatures (e.g., fingerprints), metadata, etc.) associated with the media content from broadcast, cable, and/or satellite sources.

### BRIEF DESCRIPTION OF THE DRAWINGS

FIG. 1 is a block diagram of an example system for collecting reference data from panelists.

FIG. 2 is a block diagram of an example implementation of the software meter of FIG. 1.

FIG. 3 is a block diagram of an example implementation of the central facility of FIG. 1.

FIG. 4 is a flowchart representing example machine readable instructions that may be executed to implement the software meter of FIG. 2.

FIG. 5 is a flowchart representing example machine readable instructions that may be executed to implement the central facility of FIG. 3.

FIGS. 6A and 6B is a flowchart representing example machine readable instructions that may be executed to implement the central facility of FIG. 3.

FIG. 7 is a block diagram of an example computer platform capable of executing the machine readable instructions of FIGS. 4, 5, 6A, and/or 6B to implement the example system of FIG. 1.

### DETAILED DESCRIPTION

Systems used to measure and/or monitor media exposure typically maintain (e.g., in a central database implemented on a server located at a metering entity) a collection of reference data and corresponding identifying data associated with known media content. Reference data includes: (a) content identification codes (e.g., a character string, symbol, or signal that may be embedded or otherwise associated with media content for the purpose of identifying that content or for some other purpose, such as copyright enforcement, digital rights management, tuning, etc.); (b) signatures (e.g., a data string, symbol, or signal representative of some (preferably unique) characteristic of the media content and/or a signal representing the media content; and/or (c) metadata (e.g., any information about and/or associated with the media content such as closed captioning information, electronic program guide information, program identification (PID) headers, etc.). Some codes (e.g., PID headers) are also metadata (e.g., data about data).

Generally, to detect exposure to and/or identify media, data collected from media content presented at the monitoring site (e.g., a video clip being playing on a presentation device via the Internet) is compared with reference data associated with known media content to determine the identity of the presented media content. When the comparison results in a match, the system recognizes the presented media content.

The time and date of presentation, the duration of the presentation, etc. is typically also recorded. In part, the performance of such a system relies on the size and/or accuracy of the reference collection (database). However, the amount of available media content grows each day, thereby increasing the likelihood that the reference data will be incomplete. Collecting reference data from large repositories of media content on the Internet (e.g., from iTunes®, Rhapsody®, Amazon®, Walmart®, etc.) presents scalability challenges due to the high volume of available content. The example methods and apparatus described herein address these difficulties by automatically generating and/or collecting reference data from one or more panelists (distributed sources) to quickly and efficiently produce a more comprehensive database of reference data. This collected reference data may be associated with any type(s) of media content including television programs, audio, songs, movies, video games, web sites, music videos, etc. Further, without the consent of content providers (e.g., producers, owners, authors, distributors, copyright owners, etc.), obtaining and/or generating reference data associated with new or previously unknown media content can prove to be expensive or otherwise problematic. The methods and apparatus described herein enable a media measurement entity to generate reference data (e.g., code(s) and/or signature(s)) from stored media content of panelist(s) that have the right (e.g., by purchasing the copy protected media content) to play the media content. The collected reference data (which may be generated from a presentation of copy protected content on the presentation device of the panelist and/or directly from the stored media) is not playable and, thus, the generation of the reference data does not infringe any copyrights.

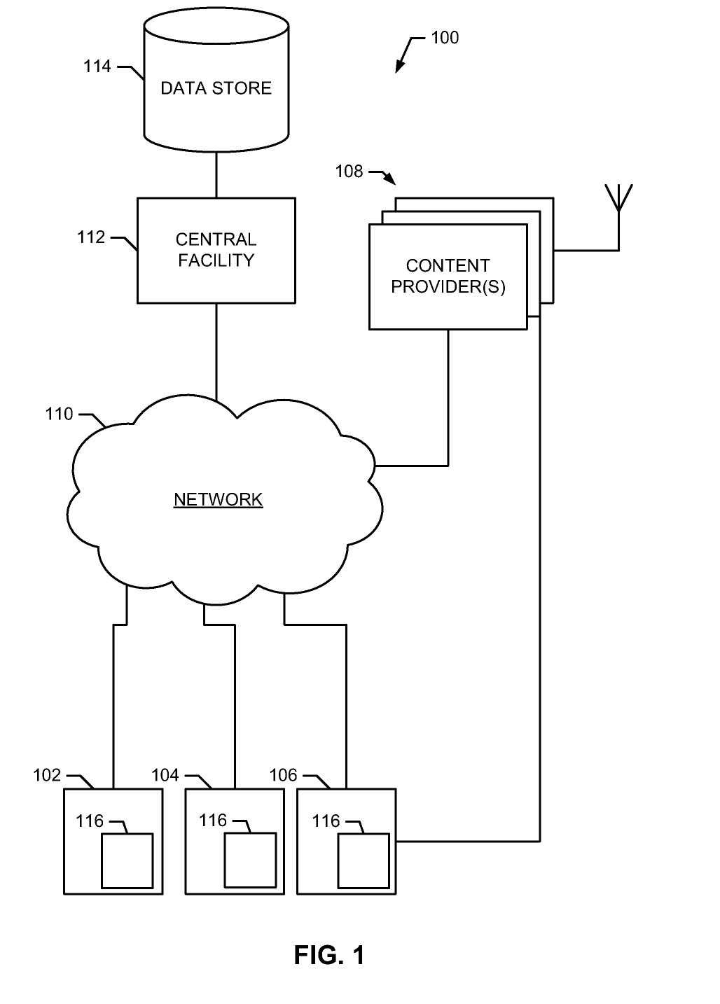

FIG. 1 illustrates an example system 100 to generate and/or collect reference data from, for example, one or more panelists. The system 100 includes a plurality of information presentation devices (three of which are illustrated at reference numerals 102, 104, and 106) at a plurality of monitoring sites, a plurality of content providers 108, a network 110, a central facility 112, and a data store 114. The information presentation devices 102, 104, and 106 may be any type of device capable of presenting and/or storing media content. For example, any or all of the information presentation devices 102, 104, and 106 may be implemented by a personal computer, a laptop computer, a media center computer, a digital video recorder, a mobile computer device, a console gaming system, a portable video/audio player, a removable media player (e.g., a digital versatile disk (DVD) player/recorder), a set top box (STB), a cell phone, a portable gaming device, a video cassette recorder/player, and/or any other type of presentation device and/or storage medium (e.g., a hard disc drive, compact disc (CD), digital versatile disk (DVD), flash memory, random access memory (RAM), etc.).

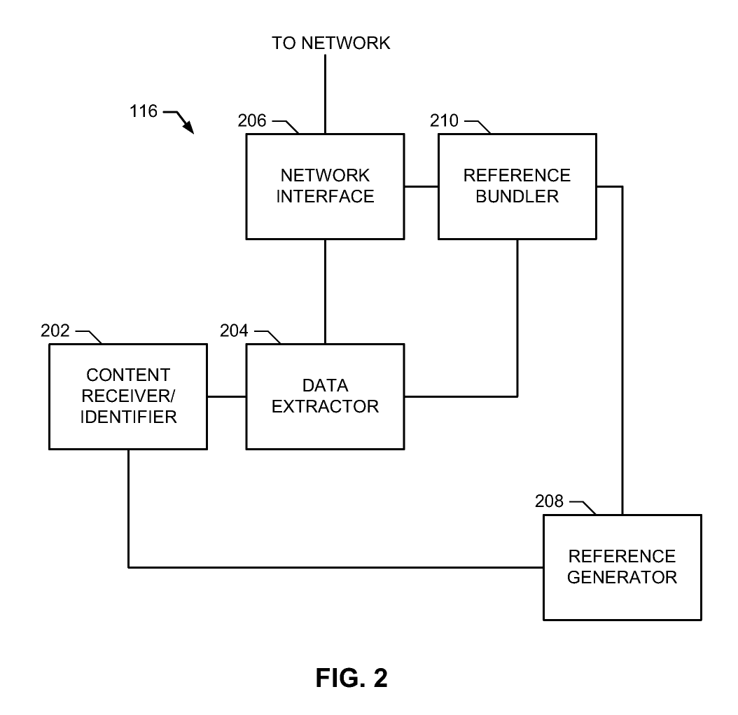

To collect reference data for a reference database, the example information presentation devices 102, 104, and 106 include a software meter 116, which is described in greater detail below in connection with FIG. 2. In the illustrated example of FIG. 1, the owner(s) and/or household(s) associated with the information presentation devices 102, 104, and 106 have been selected (e.g., statistically or randomly) and/or volunteered to participate in a monitoring panel. In particular, the owners/operators of the example information presentation devices 102, 104, and 106 have agreed to participate in the monitoring panel and to have the media content on their respective information presentation device(s) 102, 104, and 106 monitored by, for example, a media consumption metering entity. For example, where the information presentation device(s) 102, 104, and/or 106 are implemented by personal computers, the time, duration, and/or visited Internet protocol (IP) addresses of web-browser sessions may be monitored and reported (e.g., to a central database). In such instances, the software meter 116 may be integrated (e.g., via a download over the Internet or installed by a manufacturer) into existing monitoring software on the presentation device(s) 102, 104, and/or 106.

Additionally or alternatively, the participants have agreed to permit the audience measurement entity to collect reference data from their library(ies) of medica content. Additionally or alternatively, reference data may be collected from information presentation devices associated with person(s) who are not participants of the monitoring panel (e.g., anonymously). For example, the software meter 116 may be downloaded (e.g., via the Internet or removable media, such as a CD) and installed on one or more information presentation devices of any consenting party or entity. This consent may be made with or without an exchange of consideration. In some examples, the software meter 116 may be bundled with other software applications to encourage users to download and execute the software meter 116. Further, in some examples, monitoring may be performed without the consent of the owners/operators of certain information presentation devices when such consent is not required. Thus, reference data may be collected (e.g., via the software meter 116) from the presentation devices 102, 104, and 106 of members of a media consumption monitoring panel, non-members of the panel, and/or any combination thereof.

Generally, the example software meter 116 reviews any media stored at the information presentation devices 102, 104, 106 to detect identifying data (e.g., metadata identifying attributes of the media content including, for example, the file name of the media content, the format of the media content (e.g. mp3, wmv, etc.), the type of the media content, the artist(s), the copyright holder(s), etc.). The software meter 116 sends the detected identifying data (e.g., a set or subset of the data) to the central facility 112, via the network 110. In the illustrated example of FIG. 1, the identifying data sent to the central facility 112 explicitly identifies the media content (e.g., the title, the author, the copyright holder, an episode title, a version, a producer, a director, the genre, etc.). The software meter 116 also collects reference data for the media content (e.g., any program identification codes present in the media, one or more signatures or set(s) of signature(s), metadata, etc.) and sends the reference data to the central facility 112. Reference data is data that may be used to identify media content associated therewith in the absence of identifying data (e.g., by comparing a first signature from a first (unknown) media file to a second signature from a second (known) media file, it may be determined that the media content of the first and second media files are the same when the first signature substantially matches the second signature).

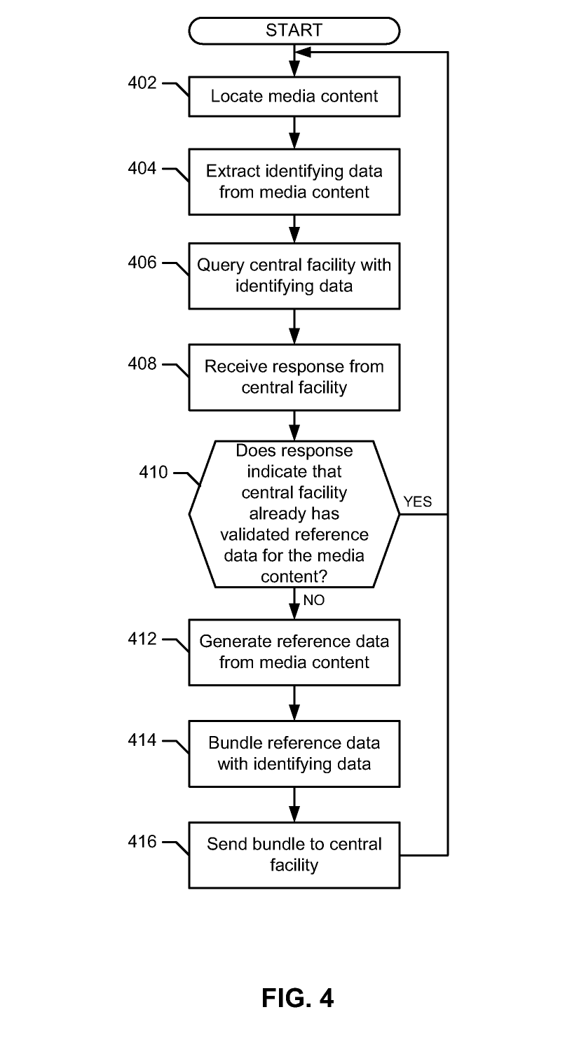

The example software meter 116 of FIG. 1 is capable of automatically locating media content on the information presentation devices 102, 104, and/or 106 on which the software meter 116 is installed. Additionally or alternatively, the software meter 116 may be capable of monitoring media content playback, download, and/or streaming (e.g., from the Internet, from another computer, from a physical media, etc.) at the information presentation device 102, 104, and/or 106 on which the software meter 116 is installed. The software meter 116 and these processes are described below in greater detail in connection with FIGS. 2 and 4. While three panelist locations and, thus, three information presentation devices are illustrated in the example system 100 of FIG. 1, any number of panelist and/or information presentation devices may be provided to implement the collection and/or generation of reference data described herein. In addition, other information presentation devices that are not monitored (e.g., do not include the software meter 116) may be connected to the network 110.

At least some of the information presentation devices 102, 104, and 106 are capable of receiving media content from the content providers 108. In addition, the information presentation devices 102, 104, and 106 may receive media content locally. For example, the information presentation devices 102, 104, and 106 may download audio and/or video content from one or more of the content providers 108 and/or may receive audio and/or video content that is downloaded from CDs, DVDs, memory cards, etc. that are inserted in the information presentation device(s) 102, 104, and 106 by the owner(s)/operator(s) of the information presentation device(s) 102, 104, and 106.

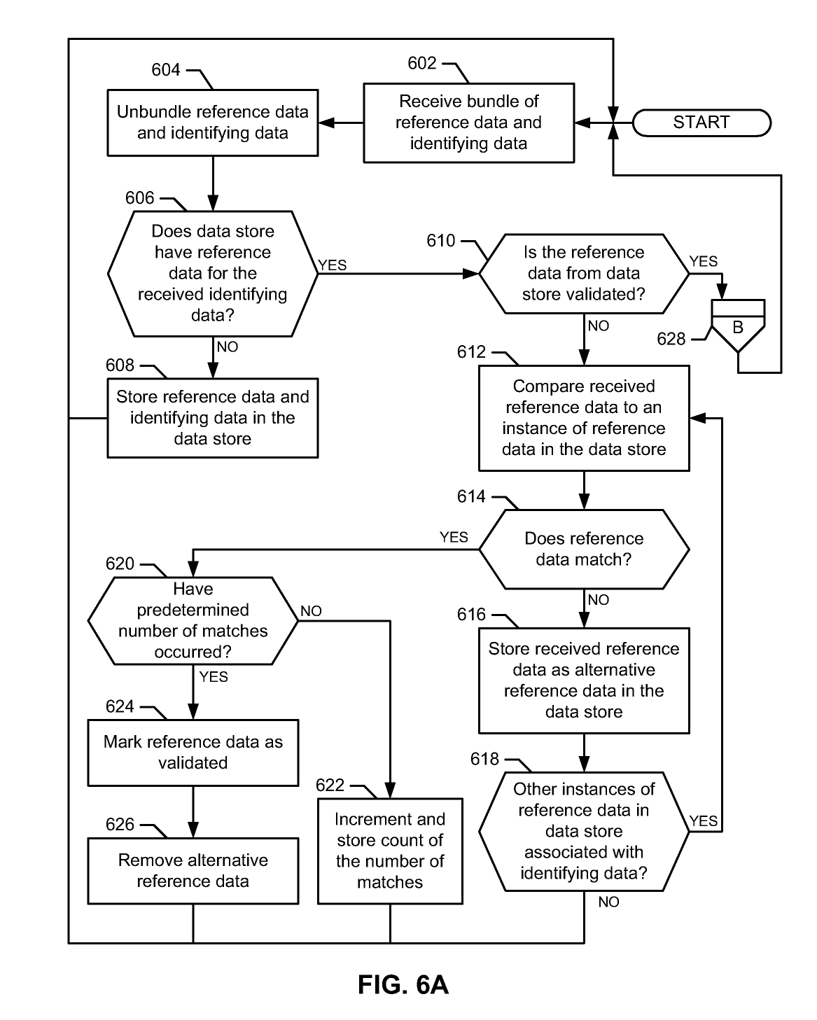

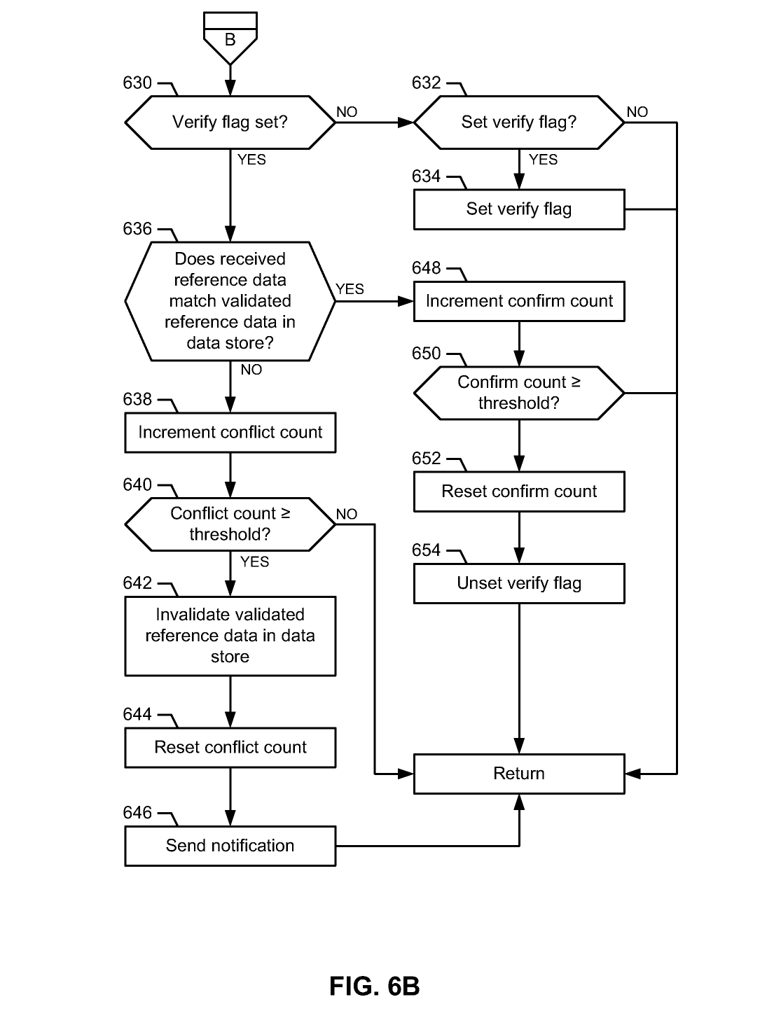

The example content providers 108 are one or more media content providers that supply media content to one or more of the information presentation device(s) 102, 104, and/or 106 via any distribution medium (e.g., cable, radio frequency, satellite, internet, physical media, etc.). Example content providers 108 include the iTunes® Media Store, Napster™, Yahoo! Music™, Rhapsody™, etc. The example content providers 108 may provide, for example, audio, video, image, text, and/or any combination thereof, in addition to identifying data associated with the provided media content. In some examples, no identifying data and/or inaccurate identifying data may be provided by the content providers 108 or by another source. For example, one of the content providers 108 may be a file transfer protocol (FTP) server provided by an individual that has (intentionally or unintentionally) mislabeled the media content. Accordingly, the identifying data (e.g., metadata) associated with media content stored on the information presentation device(s) 102, 104, and/or 106 may not always be trusted to be accurate. However, media content may include protections to ensure that identifying data remains accurate (e.g., is not altered by an end-user of external program(s)). For example, certain types of media content may include digital rights management (DRM) technology, copy protection, etc. that prevents metadata from being altered or indicates that the metadata has been altered. In view of the foregoing, the example system 100 tests data for accuracy and only trusts media content whose identify has been verified. As described below in connection with FIGS. 6A and 6B, the example system 100 (e.g., via the central facility 112) compares the number of times that matching identifying data and/or reference data are received to a threshold and only validates the data after the number exceeds the threshold (e.g., to verify whether identifying data and/or reference data can be relied upon). Unlike the example system 100, in other examples systems, the trustworthiness of metadata may not be analyzed and/or all metadata may be extracted and utilized.

In the illustrated example of FIG. 1, the information presentation devices 102, 104, and 106, the content providers 108, and the central facility 112 are communicatively coupled via any type(s) of public and/or private IP networks 110. In the illustrated example, the network 110 is implemented by the Internet. However, any type(s) of past, current, and/or future communication network(s), communication system(s), communication device(s), transmission medium(s), protocol(s), technique(s), and/or standard(s) could be used to communicatively couple the components of FIG. 1 (e.g., the content providers 108 and the central facility 112). Further, the example components of the illustrated system 100 may be coupled to the network 110 via any type(s) of past, current, and/or future device(s), technology(-ies), and/or method(s), including voice-band modems(s), digital subscriber line (DSL) modem(s), cable modem(s), Ethernet transceiver(s), optical transceiver(s), virtual private network (VPN) connection(s), Institute of Electrical and Electronics Engineers (IEEE) 802.11x (a.k.a. WiFi) transceiver(s), IEEE 802.16 (a.k.a. WiMax), access point(s), access provider network(s), etc. Further, the network 110 may be implemented by one or a combination(s) of any hardwire network, any wireless network, any hybrid hardwire and wireless network, a local area network, a wide area network, a mobile device network, a peer-to-peer network, etc. For example, a first network may connect the content providers 108 to the information presentation devices 102, 104, and 106, while a second network may connect the central facility 112 to the information presentation devices 102, 104, and 106. Further, while the example data store 114 is shown as connected directly to the example central facility 112, in some implementations, the data store 114 may be connected to the central facility 112 via the network 110 or via a second network (not shown).

The example central facility 112 is any facility or server capable of receiving and storing identifying data and/or reference data provided by, for example, a software meter 116 installed on any of the information presentation device(s) 102, 104, and/or 106. Further, the example central facility 112 facilitates storage and retrieval of identifying data and/or reference data in/from the data store 114. In the illustrated example, the central facility 112 is implemented by an audience metering facility that tracks the media exposure of, for example, members of the monitoring panel described above. While a single central facility 112 is shown in the example system 100 of FIG. 1, multiple central facilitates may be implemented in some implementations.

The example data store 114 is communicatively coupled to the central facility 112 and comprises a database that stores identifying data and reference data associated with media content (e.g., as detected by the software meter 116 and/or as obtained from other source(s)). The data store 114 may be any type of device or memory capable of storing the identifying data and reference data described herein. Although only one data store 114 is shown in FIG. 1, multiple data stores (or storage devices or memory) may be provided. Further, the example data store 114 may include multiple databases, memories, and/or other storage devices to maintain and provide access to collected data.

FIG. 2 is a block diagram of an example implementation of any of the software meter(s) 116 of FIG. 1. The example software meter 116 of FIG. 2 includes a content receiver/identifier 202, a data extractor 204, a network interface 206, a reference generator 208, and a reference bundler 210. For ease of description, the following will discuss an implementation in which the software meter 116 is installed in the information presentation device 102. However, as illustrated in FIG. 1, one or more version(s) of the software meter 116 may be additionally or alternatively installed on the information presentation device(s) 104 and/or 106, and/or on any other device capable of presenting and/or storing media content.

The example network interface 206 provides an interface between the network 110 of FIG. 1 and the software meter 116. In the illustrated example, the network interface 206 is provided by the information presentation device 102 and the software meter 116 is adapted to communicate with that network interface 206. For example, the network interface 206 may be a wired network interface, a wireless network interface, a Bluetooth network interface, etc. and may include the associated software and/or libraries needed to facilitate communication between the software meter 116 and the network 110. If the software meter 116 is provided in a device external to the information presentation device 102, the network interface 206 may be provided by the software meter 116.

The example content receiver/identifier 202 of FIG. 2 receives and/or identifies (e.g., via a search) media content stored on or accessible by the information presentation device 102. In the illustrated example, the content receiver/identifier 202 monitors media applications executing on the information presentation device 102. For example, the content receiver/identifier 202 may be a plug-in installed in Microsoft's Windows® Media Player, may monitor Apple's iTunes® software using a program interface to iTunes®, etc. In the illustrated example, the content receiver/identifier 202 searches for and/or locate media content on the information presentation device 102 regardless of whether the media content is currently being presented or has ever been presented on the information presentation device 102. In the illustrated example, the content receiver/identifier 202 searches through a directory structure of memory (e.g., a hard disk, an external memory, an attached media consumption device, such as an iPod®, etc.) connected to the information presentation device 102, and/or monitors media content as it is downloaded to the information presentation device 102 (e.g., media content downloaded from an external device, media content downloaded via a connected network, such as the network 110, etc.). Further, the content receiver/identifier 202 utilizes a combination of monitoring one or more media applications and locating media content on and/or accessible by the information presentation device 102. While the foregoing describes several ways in which the content receiver/identifier 202 accesses media content available to the information presentation device 102, any other method of locating such media content may be used.

The example content receiver/identifier 202 is configured to recognize the type (e.g., protected audio, unprotected audio, video depicted image, Windows media audio (WMA), etc.) of the media content (e.g., using metadata, using a file extension, etc.) and/or to recognize the state of the media content (e.g., media content that has been modified by an end user, media content that has not been modified, media content that has been created by an end user, etc.). The example content receiver/identifier 202 is also structured to exclude certain types of media content from (and/or to include content in certain state(s) in) the reference data collection process. For example, the content receiver/identifier 202 of the illustrated example is configured to only accept media content that has not been modified or created by an end user to increase the likelihood that identifying data and/or reference data associated with the media content is accurate. In some examples, the content receiver/identifier 202 may be configured to only accept media content that is identified as having been received from a source that has been determined to be reputable (e.g., a media content provider, such as one or more of the content providers 108 of FIG. 1, may be considered reputable whereas a user-created file may be considered non-reputable). Further, the content receiver/identifier 202 may be configured to only accept media content whose metadata is protected (e.g., encrypted) so that it cannot be changed by end users. While the foregoing provides example methods for determining which media content should be accepted by the content receiver/identifier 202, any method may be used to maximize the likelihood that identifying data (e.g., metadata) and/or reference data (e.g., a code, series of codes, signature, series of signatures, etc.) associated with the media content is accurate and/or legally accessible.

The content receiver/identifier 202 of the illustrated example indicates the availability of located media content to the data extractor 204 and the reference generator 208. For example, the content receiver/identifier 202 may send a copy of the data access path by which the located media may be retrieved to the data extractor 204 and the reference generator 208, may send a link to the media content to the data extractor 204 and the reference generator 208, may send a copy of the media content, etc.

The example data extractor 204 extracts identifying data from and/or associated with the media content located or identified by the example content receiver/identifier 202. To obtain identifying information, the data extractor 204 may utilize any available method for locating, for example, metadata identifying one or more attributes (e.g., a title, artist, album, an episode title, a version, a producer, a director, etc.) of the media content. For example, the data extractor 204 may extract metadata that is embedded or hidden in the media content itself, receive metadata from a media application (e.g., a media handler) that is processing or has processed the media content, retrieve metadata from a local or external database associated with the media content (e.g., an iTunes® library database), prompt the owner/operator of the information presentation device 102 for identifying information associated with the media content, etc.

In the illustrated example, the data extractor 204 conveys the extracted identifying data to the central facility 112 of FIG. 1, via the network interface 206, along with a query requesting that the central facility 112 indicate whether reference data for the media content associated with the identifying data is already included at the central facility 112 (e.g., stored in the data store 114 of FIG. 1). If the central facility 112 responds (e.g., via the network interface 206) with a message indicating that the reference data associated with the extracted identifying information has not been stored or is not validated (e.g., an insufficient number of information presentation devices have sent matching reference data for the associated media content), the data extractor 204 conveys the extracted identifying data to the reference bundler 210. Alternatively, the data extractor 204 may not query the central facility 112 and, rather, may send the identifying data to the reference bundler 210 after every detection/extraction. In other words, as described below in connection with FIGS. 6A and 6B, bundled identifying data and reference data may be conveyed to the central facility 112 without first querying the central facility 112.

The example reference generator 208 generates reference data for media content located by the content receiver/identifier 202. As described above, the generated reference data is data that may be used to identify the media content in the absence of reliable identifying data. For example, the reference data may be a signature comprising a (preferably unique) characteristic of the media content that can serve as a proxy for the complete content. Generally, the example reference generator 208 may extract metadata from the media content, may generate one or more signatures of the media content, may recognize one or more watermarks (e.g., source or content identification codes or other data embedded in and/or otherwise associated with, the media content, etc. Further, the reference generator 208 transmits the one or more types of generated reference data to the reference bundler 210. Preferably, the reference generator 208 collects and/or generates all available type(s) of reference data. Alternatively, if the central facility 112 responds that only a certain type of reference data is needed for that particular piece of content (e.g., a code), only that particular type of reference data is sent (if available) to the central facility 112.

The example reference bundler 210 receives identifying data from the data extractor 204 and reference data from the reference generator 208 and combines the identifying data and the reference data for transmission to the central facility 112, via the network interface 206. Any method of combining and/or associating the identifying data and the reference data may be used. For example, the reference bundler 210 may combine the identifying data and the reference data in a zip file, may associate the same index value with the identifying data and the reference data, may send either one or both of the identifying data and the reference data with a message indicating that they are associated with each other, etc.

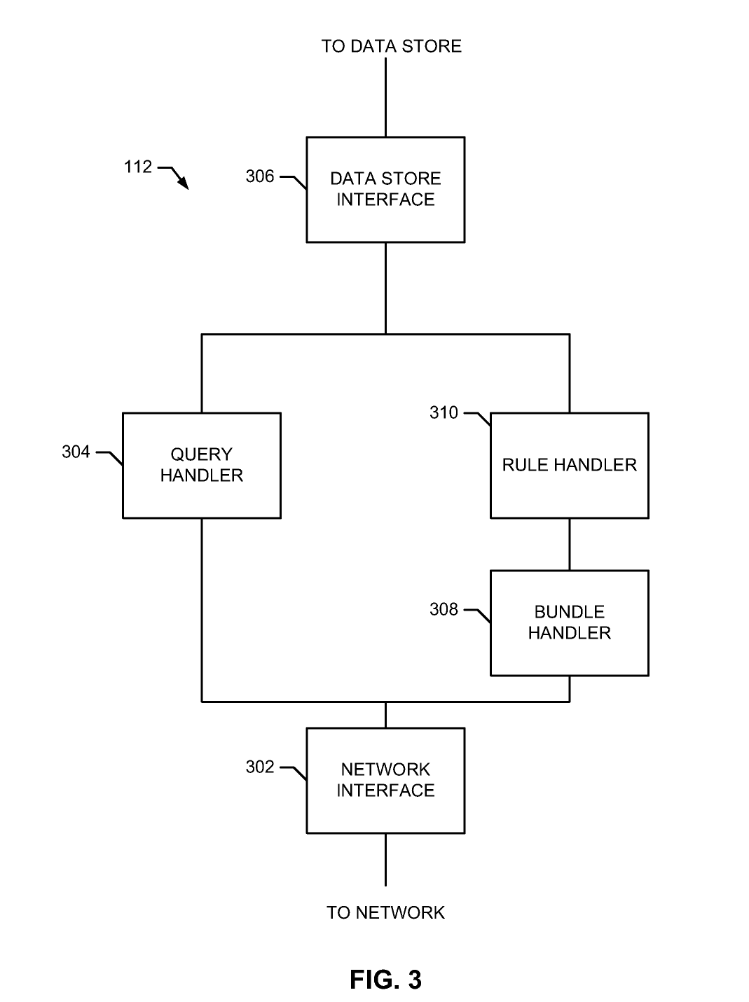

FIG. 3 is a block diagram of an example implementation of the central facility 112 of FIG. 1. The example central facility 112 includes a network interface 302, a query handler 304, a data store interface 306, a bundle handler 308, and a rule handler 310. The example network interface 302 provides an interface between the network 110 and the central facility 112. For example, the network interface 302 may be a wired network interface, a wireless network interface, a Bluetooth network interface, etc. and may include the associated software needed to facilitate communication between the central facility 112 and the network 110.

The example query handler 304 receives a query (e.g., from the data extractor 204 of FIG. 2), which includes identifying information associated with located media content, queries the data store 114, and sends a response to the software meter 116 based on the result(s) of the query. For example, the query handler 304 may send a response indicating that the identifying data was found in the data store 114 with associated reference data that is validated, that the identifying data was found in the data store 114 with associated reference data that has not been validated, or that the identifying data was not found in the data store 114. The response may be sent immediately or may be intentionally or necessarily delayed. For example, the query handler 304 may implement a waiting period and/or may wait for a sufficient number of bundles of reference data and identifying data before sending one or more responses. While the query handler 304 of the illustrated example of FIG. 3 is described as receiving identifying information for querying the data store 114, the query handler 304 may alternatively receive reference data that may be used to query the data store 114 to determine if the reference data is already stored and/or validated in the data store 114 and/or to identify the corresponding media content.

The example data store interface 306 facilitates communication between the central facility 112 and the data store 114 of FIG. 1. As described above, while the central facility 112 and the data store 114 are shown separately in the illustrated example, the data store 114 is part of the central facility 112. Alternatively, the data store 114 may be separately located from the central facility 112. The data store interface 306 may be any type of interface such as, for example, a network interface (e.g., a wired network interface, a wireless network interface, a Bluetooth network interface, etc.), a serial data interface, a parallel data interface, etc. In addition, in an example implementation in which the data store 114 is integrated with the central facility 112, the data store interface 306 may be a software interface.

The example bundle handler 308 receives a bundle of identifying data and reference data (e.g., as generated by the reference bundler 210 of FIG. 2) and separates the identifying data from the reference data. For example, if the bundle is a zip file, the file is unzipped and the reference data and the associated identifying data are extracted. The bundle handler 308 conveys the identifying data and/or the reference data to the example rule handler 310. The example rule handler 310 then determines if the reference data and/or identifying data should be stored in the data store 114. For example, the rule handler 310 may calculate how many times matching reference data has been received in association with the corresponding identifying data (e.g., to determine whether the reference data stored at the data store 114 is valid). Such a determination is described in greater detail below in connection with FIG. 4-6. If the rule handler 310 determines that the identifying data and/or the reference data is to be stored, the rule handler 310 transmits the identifying data and the reference data to the data store 114 via the data store interface 306.

While an example manner of implementing the software meter(s) 116 of FIG. 1 has been illustrated in FIG. 2, one or more of the elements, processes and/or devices illustrated in FIG. 2 may be combined, divided, re-arranged, omitted, eliminated and/or implemented in any other way. While an example manner of implementing the central facility 112 of FIG. 1 has been illustrated in FIG. 3, one or more of the elements, processes and/or devices illustrated in FIG. 3 may be combined, divided, re-arranged, omitted, eliminated and/or implemented in any other way. Further, the example content receiver/identifier 202, the example data extractor 204, the example network interface 206, the example reference generator 208, the example reference bundler 210, and/or, more generally, the example software meter 116 of FIG. 2 may be implemented by hardware, software, firmware and/or any combination of hardware, software and/or firmware. Further, the example network interface 302, the example query handler 304, the example data store interface 306, the example bundle handler 308, the example rule handler 310, and/or, more generally, the example central facility 112 of FIG. 3 may be implemented by hardware, software, firmware and/or any combination of hardware, software and/or firmware. Further the example data store 114 of FIG. 1 may be implemented by hardware, software, firmware and/or any combination of hardware, software and/or firmware. Thus, for example, any of the example central facility 112, the example data store 114, the example software meter(s) 116, the example content receiver/identifier 202, the example data extractor 204, the example network interface 206, the example reference generator 208, the example reference bundler 210, the example network interface 302, the example query handler 304, the example data store interface 306, the example bundle handler 308, and/or the example rule handler 310, could be implemented by one or more circuit(s), programmable processor(s), application specific integrated circuit(s) (ASIC(s)), programmable logic device(s) (PLD(s)), and/or field programmable logic device(s) (FPLD(s)), etc. When any of the appended claims are read to cover a purely software implementation, at least one of the example central facility 112, the example data store 114, the example software meter(s) 116, the example content receiver/identifier 202, the example data extractor 204, the example network interface 206, the example reference generator 208, the example reference bundler 210, the example network interface 302, the example query handler 304, the example data store interface 306, the example bundle handler 308, and/or the example rule handler 310 are hereby expressly defined to include a tangible medium such as a memory, DVD, CD, etc. Further still, the example software meter 116 of FIG. 2 and/or the example central facility 112 of FIG. 3 may include one or more elements, processes and/or devices in addition to, or instead of, those illustrated in FIGS. 2 and/or 3, and/or may include more than one of any or all of the illustrated elements, processes and devices.

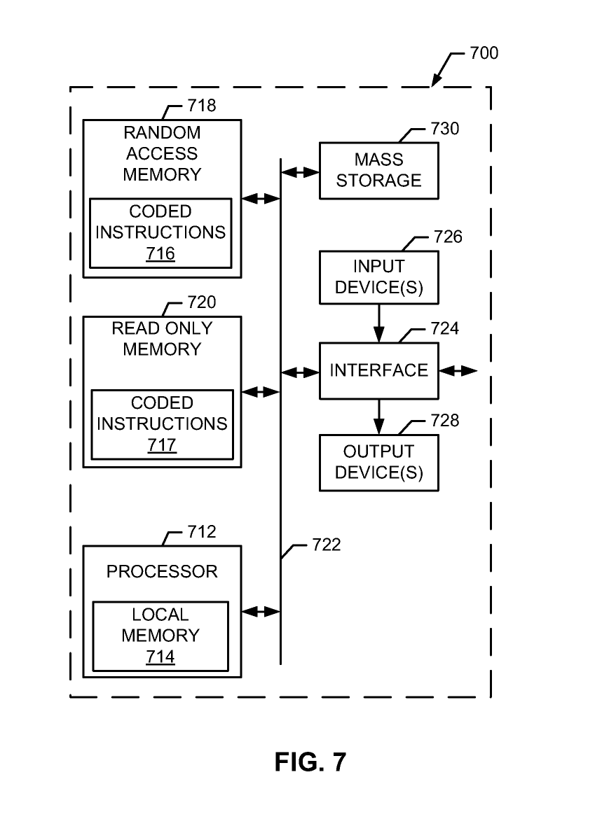

FIGS. 4-6 are flowcharts representative of example machine readable instructions that may be executed (e.g., by the example computer platform 700 of FIG. 7) to implement the example system 100 of FIGS. 1-3 and/or the components thereof. The example machine readable instructions of FIGS. 4-6 may be executed by a processor, a controller, and/or any other suitable processing device. For example, the example machine readable instructions of FIGS. 4-6 may be embodied in coded instructions stored on a tangible medium such as a flash memory, or random access memory (RAM) (e.g., the RAM 718 shown in the example processor platform 700 and discussed below in connection with FIG. 7) associated with a processor (e.g., the processor 712. Alternatively, some or all of the example flowcharts of FIGS. 4-6 may be implemented using an application specific integrated circuit (ASIC), a programmable logic device (PLD), a field programmable logic device (FPLD), discrete logic, hardware, firmware, etc. In addition, some or all of the example flowcharts of FIGS. 4-6 may be implemented manually or as a combination of any of the foregoing techniques (e.g., any combination of firmware, software, hardware, and/or discrete logic). Although the machine readable instructions of FIGS. 4-6 are described with reference to the example flowcharts of FIGS. 4-6, other methods of implementing the software meter 116 and/or, more generally, the system 100 of FIG. 1 may be employed. For example, the order of execution of the blocks may be changed, and/or some of the blocks described may be changed, eliminated, sub-divided, and/or combined. Additionally, the example machine readable instructions of FIGS. 4-6 may be carried out sequentially and/or carried out in parallel by, for example, separate processing threads, processors, devices, circuits, etc. Further, any or all of the example components of the example system 100 (e.g., the content providers 108, the central facility 112, the data store 114, the software meter 116, the content receiver/identifier 202, the data extractor 204, the network interface 206, the reference generator 208, the reference bundler 210, the network interface 302, the query handler 304, the data store interface 306, the bundle handler 308, and/or the rule handler 310) may be implemented by hardware, software, firmware, and/or any combination thereof.

The flowchart of FIG. 4 illustrates example machine readable instructions that may be executed to implement, for example, the software meter 116 of FIG. 1. The example machine readable instructions of FIG. 4 begin when the content receiver/identifier 202 of the software meter 116 locates media content on, for example, one ore more of the information presentation device(s) 102, 104, and/or 106 of FIG. 1, a database, a server, and/or on any other device on which the software meter 116 is installed (block 402). The data extractor 204 then extracts identifying data (e.g., metadata) associated with the located media content (block 404). By way of illustration, where the located media comprises a song, the extracted identifying data may be an artist or song title. In the illustrated example, the data extractor 204 then conveys the identifying data to the central facility 112 of FIG. 3 as part of a query into the contents of the central facility 112 and/or any related or operatively connected storage device (e.g., the data store 114) (block 406). More specifically, the query is intended to determine whether any data (e.g., reference data, such as a code and/or signature) is stored at the central facility 112 for the media content associated with the extracted identifying data.

The meter 116 then receives a response to the query from the central facility 112 via the network interface 206 (block 408). The central facility 112 may send responses periodically (e.g., every three or five minutes), at certain times (e.g., 2 am), continuously (e.g., immediately after the queries have been resolved), and/or after a predetermined amount of queries (e.g., ten) have been received or resolved. Further, the responses may be conveyed individually or as a group. The precise methodology employed may be wholly or partially dependent on the type or interconnectivity (e.g., whether some or all of the quer(ies) include similar or identical identifying information) of one or more of the received queries. The meter 116 then determines if the received response indicates that the central facility 112 currently includes validated reference data (e.g., data that has been validated by the method(s) described in connection with FIGS. 6A and 6B) for the identified media content (block 410). If so, control returns to block 402. In some alternative implementations, the meter 116 may generate and convey reference data without first querying the central facility 112.

If the received response indicates that the central facility 112 does not currently include validated reference data for the media content associated with the extracted identifying data (block 410), the reference generator 208 of the meter 116 generates and/or extracts reference data from the media content (block 412). Generation and/or extraction of reference data may be deferred until the resources of the device on which the meter 116 is installed are available (e.g., generation and/or extraction may be delayed until an information presentation device is idle, until no user input has been received for a predetermined period, until a time of day at which an information presentation device is not likely being used, etc.). Additionally or alternatively, generation and/or extraction tasks for more than one instance of media content may be grouped and performed when a sufficient number of instances of media content have been located.

The reference bundler 210 then bundles the extracted identifying data with the generated reference data from the reference generator 208 (block 414). The resulting bundle is conveyed to the central facility 112 for storage (e.g., in the data store 114) (block 416). Conveying data to the central facility 112 may occur during assigned times of day, when a predetermined amount of data is ready to be conveyed, as soon as any data is ready to be conveyed, or on any other basis. Control then returns to block 402 to process the next instance (if available) of media content.

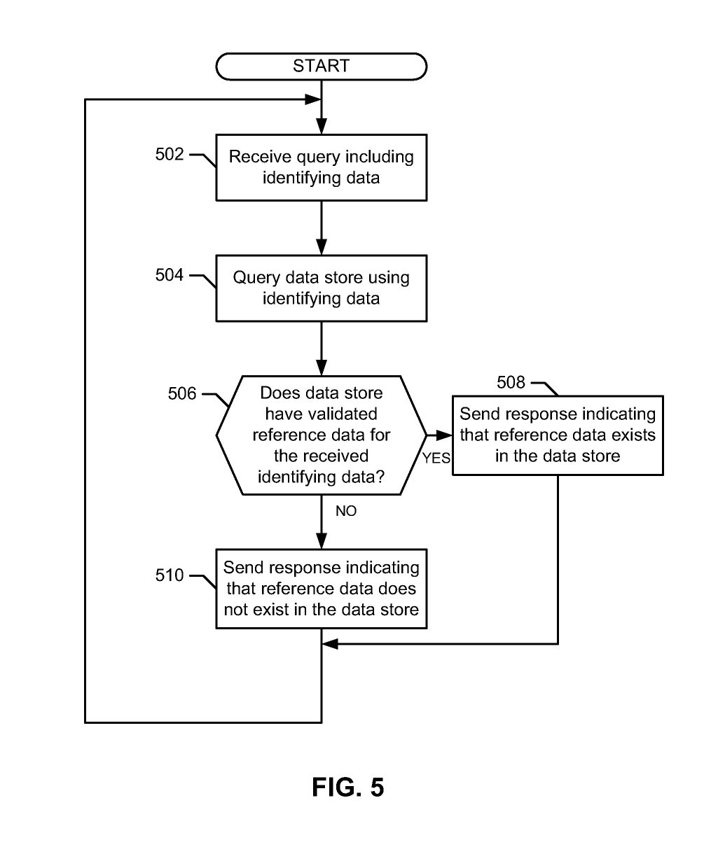

The flowchart of FIG. 5 illustrates example machine readable instructions that may be executed to implement the central facility 112. Specifically, the machine readable instructions of FIG. 5 may be executed to process a query from the meter 116. The example machine readable instructions of FIG. 5 begin when the query handler 304 of the central facility 112 receives a query via the network interface 302 of FIG. 3. The query includes identifying data (and/or, in some examples, reference data) associated with media content from the meter 116 (block 502). The received identifying data is used to query the data store 114 of FIG. 1 to determine if reference data has been stored for the media content associated with the identifying data (block 504). For example, a directory, index, or memory structure may be searched for matching identifying data and a response may be generated to indicate the presence or absence of a match. Based on the response to the query of the data store 114, the query handler 304 determines if validated reference data has been stored for the identified media content (block 506). For example, an entry in the data store 114 may include a flag, bit, or other indicator (e.g., a binary value) to signify that the data of the entry is valid or invalid. The indicator may be initially set to, for example, a high value in instances wherein the data was received from a trusted source (e.g., directly from the author, artist, or production company). Thus, reference data for certain instances of media content (e.g., an instance from such highly trusted sources) may only need to be generated and/or collected once. The indicator may also be set based on a number of matches and/or the degree of matching between received data and the data of the data store 114. If validated reference data has been stored for the identified media content, the central facility 112 conveys a response to the meter 116 indicating that validated reference data exists in the data store 114 (block 508).

Returning to block 506, in the illustrated example, if validated reference data has not been stored for the identified media content, the query handler 304 of the central facility 112 conveys a response to the meter 116 indicating that the data store 114 does not include validated reference data for the corresponding media content (block 510). The response may be sent immediately or at a later time such as, for example, the next time that the meter 116 performs a regular data collection cycle. As described above in connection with FIG. 4, in accordance with the response sent by the central facility 112, the meter 116 may or may not convey a bundle of data (including the identifying data and any generated and/or extracted reference data) to be stored in the data store 114. Control may then return to block 502 to await the receipt of another query.

The flowchart of FIGS. 6A and 6B illustrates example machine readable instructions that may be executed to implement the central facility 112 of FIG. 1. In particular, the machine readable instructions of FIGS. 6A and 6B may be executed to process bundled data received from any of the meters 116. The example machine readable instructions of FIGS. 6A and 6B begin when the central facility 112 receives, via the bundle handler 308 of FIG. 3, a bundle of reference data and identifying data from the reference bundler 210 of the meter 116 (block 602). For example, the meter 116 may have queried the central facility 112 with identifying data associated with media content located on a corresponding media presentation device at a panelist's site (e.g., a movie or song on a personal computer), received a response indicating a lack of corresponding validated reference data, and, accordingly, may have conveyed the bundled data to the central facility 112 for storage. Further, in some examples, the meter 116 may have sent the bundled data to the central facility 112 without first sending a query regarding the presence (or absence) of validated reference data associated with located media content. The contents of the bundle are then unbundled (e.g., unzipped) by the bundle handler 308 to obtain the reference data and/or identifying data (block 604).

The query handler 304 of the central facility 112 then determines if the data store 114 includes any reference data associated with the received identifying data (block 606). For example, even when the central facility 112 indicated to the meter 116 (e.g., after being queried) that no validated reference data is present, the data store 114 may include instances of unvalidated reference data (e.g., reference data that has not been received enough times (e.g., X times to be considered accurate). Further, where the central facility 112 was not first queried, either validated or unvalidated reference data may exist in the data store 114. If, for example, the identifying data is being received for the first time and no corresponding reference data has been stored, the central facility 112 stores the unbundled reference data and the corresponding identifying data in the data store 114 by creating an entry or record for the same (block 608). Control then returns to block 602.

If, at block 606, the data store 114 contains one or more instances of reference data associated with the received identifying data, the query handler 304 of the central facility 112 further inquires into the validity of the stored reference data (block 610). If the stored reference data in the data store 114 has been validated, control passes to block 628, which is described below in connection with FIG. 6B. For example, reference data may be validated when matching reference data and identifying data have been received from a predetermined number (e.g., two, ten, etc.) of information presentation device(s) (e.g., the information presentation device(s) 102, 104, and/or 106).

Otherwise, if the data has not been validated (block 610), the query handler 304 compares the received reference data to an instance of stored reference data (block 612). The data store 114 may contain one or more instances (e.g., versions) of the reference data associated with the received identifying data due to, for example, alterations made (intentionally or unintentionally) by end users of the media content.

If the instance of reference data from the data store 114 does not match the received reference data (block 614), the rule handler 310 stores the received reference data in the data store 114 in association with the corresponding identifying data (block 616). For example, the reference data may be stored as alternative reference data (e.g., the data store 114 may store both instances of the reference data associated with the identifying data). If the data store 114 does not contain more instances of reference data associated with the received identifying data (block 618), control returns to block 602. Otherwise, control returns to block 612 where the received reference data is compared to another instance of reference data in the data store 114.

Referring again to block 614, if the received reference data matches reference data from the data store 114, the rule handler 310 determines if a predetermined number of matching instances of reference data associated with the received identifying data have been received (block 620). For example, each entry of identifying data and corresponding reference data in the data store 14 may include a count for the number of times that the matching instances of reference data (and/or identifying data) have been recognized. If the predetermined number of matches has not occurred, the count is incremented and stored (block 622). Referring back to block 616, in some examples, where the reference data does not match the received reference data, the count may be decremented or set back to zero to indicate that the reference data is unvalidated. Control then returns to block 602. If the predetermined number of matches have occurred (block 620), the reference data is marked as validated in the data store 114 (block 624). In the illustrated example, any unvalidated, alternative reference data that may have been stored in association with the received identifying data is removed (e.g., erased from the data store 114) (block 626). Control then returns to block 602 where the central facility 112 awaits receipt of another bundle of data at the bundle the handler 308.

While alternative reference data is removed in block 626 of the example flowchart of FIG. 6A, in some implementations alternative reference data may be retained. In addition, the count of the number of matches of reference data may be retained. Further, the reference data having the largest number of matches (or the largest number of matches over a predetermined period of time) may be considered to be validated and, thus, the most accurate reference data associated with the identified media content, but the alternative versions are retained.

Referring again to block 610, when the data store 114 includes validated reference data associated with the received identifying data, control passes to block 630 of FIG. 6B via block 628. FIG. 6B illustrates example machine readable instructions that may be executed to implement a confirmation process for validated reference data. Generally, in the illustrated example, the central facility 112 periodically or aperiodically tests the accuracy of validated reference data by comparing the validated reference data to reference data received from the reference bundler 210 of FIG. 2. The frequency or periodicity of the confirmation process is determined by a set of rules or guidelines implemented by the rule handler 310 of FIG. 3. For example, the confirmation process may be run once per unit of time (e.g., a calendar day, week, or month), after receiving a predetermined number of instances of identifying data associated with the validated reference data, and/or according to any other suitable policy. Thus, the confirmation process may serve as a spot check for reference data that, for example, has recently been validated.

In the illustrated example, some or all of the entries of validated reference data in the data store 114 include a verify flag, which is controlled by the rule handler 310, to indicate whether the confirmation process is to be executed for the corresponding entry. If the verify flag indicates that the confirmation process is not to be executed (e.g., the verify flag is set to low) (block 630), the rule handler 310 determines if the confirmation process is to be executed upon the next receipt of similar identifying data and/or reference data (block 632). If not, control returns to block 602 of FIG. 6A. If so, the verify flag is set (e.g., to high) (block 634). For example, the rule handler 310 may set the verify flag when an entry of reference data has been validated for greater than two weeks or some number (e.g., ten) of instances of the received identifying data has been received since the reference data was validated. This information may be tracked by a count associated with the reference data and stored in the data store 114. Control then returns to block 602 of FIG. 6A.

Referring again to block 630, if the verify flag is set, the query handler 304 of FIG. 3 compares the received reference data to the stored validated reference data (block 636). If the received reference data does not substantially match the stored validated reference data, the rule handler 310 increments a conflict count (block 638) and then determines if the conflict count meets or exceeds a first predetermined threshold of conflicts or mismatches (block 640). The conflict count represents how many mismatches have been received in association with the corresponding reference data and is managed by the rule handler 310 and stored in the data store 114 (e.g., linked to the corresponding reference data and/or identifying data). If the conflict count does not meet or exceed the first predetermined threshold, control returns to block 602 of FIG. 6A. Otherwise, the validated reference data is invalidated (e.g., by unsetting a valid bit associated with the reference data) (block 642) and the conflict count is reset (e.g., to zero) (block 644). Further, in the illustrated example, a notification (e.g., electronic message via an email server) is sent to, for example, an operator or administrator of the central facility 112 including information regarding the invalidation of the reference data. Such information may include times, dates, number of mismatches, identifying information (e.g., metadata), etc. Control then returns to block 602 of FIG. 6A.

Referring again to block 636, if the received reference data substantially matches the stored validated reference data, the rule handler 310 increments a confirm count (block 648) and then determines if the confirm count meets or exceeds a second predetermined threshold of confirmations or matches (block 650). The confirm count represents how many matches have been received in association with the corresponding reference data since the verify flag was set and is managed by the rule handler 310 and stored in the data store 114 (e.g., linked to the corresponding reference data and/or identifying data). If the confirm count does not meet or exceed the second predetermined threshold, control returns to block 602 of FIG. 6A. Otherwise, the rule handler 310 resets the confirm count associated with the reference data (block 652) and the verify flag is unset (e.g., set to low) to indicate that the reference data has been confirmed as accurate (block 654). Control then returns to block 602 of FIG. 6A.

The methods and apparatus described herein enable an automatic development of a reference library of media content from distributed sources (e.g., homes, individuals, businesses, etc.) that preferably agree to provide access to the content at their location. In some examples, the distributed sources are participants (e.g., panelists, such as Nielsen® families) in an audience measurement research stuffy. The automatically generated reference library can be used, for example, in audience measurement applications and/or digital rights management applications wherein media content is identified by reference to the reference library.

FIG. 7 is a block diagram of an example processor platform 700 capable of executing the machine readable instructions illustrated in FIGS. 4, 5, 6A and/or 6B to implement the system 100 of FIG. 1. The example processor platform 700 of the instant example includes a processor 712 such as a general purpose programmable processor. The processor 712 includes a local memory 714, and executes coded instructions 716 present in random access memory 718, coded instruction 717 present in the read only memory 1020, and/or instructions present in another memory device. The processor 712 may execute, among other things, the machine readable instructions represented in FIGS. 4-6. The processor 712 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 712 is in communication with a main memory including a volatile memory 718 and a non-volatile memory 720 via a bus 722. The volatile memory 718 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 720 may be implemented by flash memory and/or any other desired type of memory device. Access to the main memory 718, 720 may be controlled by a memory controller (not shown).

The processor platform 700 also includes an interface circuit 724. The interface circuit 724 may be implemented by any type of interface standard, such as an Ethernet interface, a universal serial bus (USB), and/or a third generation input/output (3GIO) interface.

One or more input devices 726 are connected to the interface circuit 1024. The input device(s) 726 permit a user to enter data and commands into the processor 712. The input device(s) can be implemented by, for example, a keyboard, a mouse, a touchscreen, a track-pad, a trackball, isopoint and/or a voice recognition system.

One or more output devices 728 are also connected to the interface circuit 724. The output devices 728 can be implemented, for example, by display devices (e.g., a liquid crystal display, a cathode ray tube display (CRT), a printer and/or speakers). The interface circuit 724 may, thus, include a graphics driver card.

The interface circuit 724 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The processor platform 700 also includes one or more mass storage devices 730 for storing software and data. Examples of such mass storage devices 730 include floppy disk drives, hard drive disks, compact disk drives and digital versatile disk (DVD) drives.

Although certain methods, apparatus, and articles of manufacture have been described herein, the scope of coverage of this patent is not limited thereto. To the contrary, this patent covers all methods, apparatus, and articles of manufacture fairly falling within the scope of description.

1. A method of developing a reference database to identify media content, comprising:
locating first local media content on a first information presentation device;
extracting first identifying data associated with the first local media content;
querying a central facility with the first identifying data; and
in response to an indication from the central facility that the reference database lacks validated reference data associated with the first identifying data, generating first reference data from the first local media content.

2. A method as defined in claim 1, further comprising installing a meter on the first information presentation device.

3. A method as defined in claim 1, wherein generating the first reference data comprises generating the first reference data via a meter.

4. A method as defined in claim 2, wherein installing the meter further comprises downloading software from a network and executing the software on the first information presentation device.

5. A method as defined in claim 1, further comprising conveying the first reference data to the central facility.

6. A method as defined in claim 1, further comprising bundling the first reference data with the first identifying data.

7. A method as defined in claim 1, wherein generating the first reference data is performed at a time at which a user is not using the first information presentation device.

8. A method as defined in claim 1, wherein generating the first reference data is performed at a time at which a user is unlikely to be using the first information presentation device.

9. A method as defined in claim 1, wherein the first identifying data comprises at least one of a title, an author, an artist, an album, an episode title, a version, a producer, a director, or a copyright holder.

10. A method as defined in claim 1, wherein the first reference data is at least one of a signature or a code.

11. A method as defined in claim 1, wherein the first information presentation device is associated with a panelist in an audience measurement study that has agreed to provide access to the first local media content.

12. A method as defined in claim 1, wherein the first reference data cannot be used to play the first local media content.

13. A method as defined in claim 1, wherein the first reference data includes every type of reference data available for the first local media content.

14. A method as defined in claim 1, wherein the first reference data includes a first type of reference data not yet present in the reference database for the first local media content, but excludes a second type of reference data already present in the reference database for the first local media content.

15. A method as defined in claim 1, wherein the first information presentation device is located at a first geographic location and further comprising locating second local media content on a second information presentation device located at a second geographic location different from the first geographic location.

16. A method as defined in claim 15, further comprising extracting second identifying data associated with the second local media content.

17. A method as defined in claim 16, further comprising querying the central facility with the second identifying data associated with the second local media content.

18. A method as defined in claim 17, further comprising, in response to an indication from the central facility that the reference database lacks validated reference data associated with the second identifying data, generating second reference data from the second local media content.

19. A method as defined in claim 18, further comprising conveying the second identifying data and the second reference data to the central facility.

20. A method as defined in claim 19, further comprising comparing the first reference data to the second reference data.

21. A method as defined in claim 20, further comprising incrementing a count in response to determining that the first and second reference data are substantially similar.

22. A method as defined in claim 21, further comprising validating the first reference data when the count reaches a threshold.

23. A method as defined in claim 20, further comprising decrementing a count in response to determining that the first and second reference data are substantially different.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A system to collect reference data into a reference database, comprising:
a set of meters on a corresponding set of geographically disposed information presentation devices to detect local media content accessible at their respective information presentation devices; and
a central facility to receive reference data from the meters and to add the received reference data to the reference database.

38. A system as defined in claim 37, wherein the reference data was not in the reference database prior to receiving the reference data from one of the meters.

39. A system as defined in claim 37, wherein at least one of the meters detects local media content by monitoring at least one of presentation or download activity on a corresponding information presentation device.

40. A system as defined in claim 37, wherein at least one of the meters detects media content by performing a search of a memory of a respective one of the information presentation devices.

41. A system as defined in claim 37, wherein at least one of the information presentation devices comprises a personal computer, a laptop computer, a media center computer, a digital video recorder, a portable computer device, a console gaming system, a removable media player, a set top box, or a cell phone.

42. A system as defined in claim 37, wherein the local media content is non-broadcast media content.

43. A system as defined in claim 37 wherein the local media content is purchased audio content.

44. A system as defined in claim 37, wherein the local media content is purchased MP3 files.

45. A system as defined in claim 37, wherein the local media content is purchased audio-video content.

46. A meter to provide data associated with local media content to a central database, comprising:
a content identifier to search an information presentation device for local media content;
a data extractor to extract identifying information associated with the local media content and to forward the identifying information to a central facility; and
a reference generator to generate reference data associated with the local media content.

47. (canceled)

48. (canceled)

49. A meter as defined in claim 46, further comprising a reference bundler to bundle the identifying information with the generated reference data, wherein bundled information is conveyed to the central facility.

50. (canceled)

51. (canceled)

52. (canceled)

53. (canceled)

54. (canceled)

55. A meter as defined in claim 46, wherein the local media content is non-broadcast media content.

56. A meter as defined in claim 46, wherein the local media content is purchased audio content.

57. A meter as defined in claim 46, wherein the local media content is purchased MP3 files.

58. A meter as defined in claim 46, wherein the local media content is purchased audio-video content.

59-77. (canceled)
